(19) United States
(12) Patent Application Publication
(10) Pub. No.: US 2012/0138088 A1
(43) Pub. Date: Jun. 7, 2012

(54) Apparatus for Combination Brush and Shampoo Dispenser

(76) Inventor: Dennis Tumale, Puunene, HI (US)

(21) Appl. No.: 13/309,277

(22) Filed: Dec. 1, 2011

Related U.S. Application Data
(60) Provisional application No. 61/419,702, filed on Dec. 3, 2010.

(51) Int. Cl. B08B 1/00; A46B 11/02; A46B 11/06; B08B 3/00

(52) U.S. Cl. 134/6; 401/268; 401/42; 401/183

(57) ABSTRACT

An apparatus, system, and method are disclosed for a combination brush and shampoo. The apparatus includes a handle, a brush head extending outward from a first end of the handle, the brush head having a plurality of apertures, an end coupler connected with a second end of the handle, a main channel extending from the end coupler, through the handle and brush head to the bristle pack such that the end coupler is in fluid communication with the plurality of apertures, and a reservoir formed in the brush head having a cleaning agent channel extending to and intersecting with the main channel. The system includes the apparatus and a semi-rigid region in the reservoir configured to be depressed and force the cleaning agent out of the reservoir. The method includes providing the apparatus, ejecting cleaning agent, and rinsing with water.

### CROSS-REFERENCES TO RELATED APPLICATIONS

This application claims priority to, U.S. Provisional Patent Application No. 61/419,702 entitled “APPARATUS FOR COMBINATION BRUSH AND SHAMPOO DISPENSER” and filed on Dec. 3, 2010 for Dennis Tumale, which is incorporated herein by reference.

### BACKGROUND

1. Technical Field

This disclosure relates to grooming products and more particularly relates to a hybrid brush and shampoo dispenser.

2. Description of the Related Art

People across the world keep animals as pets, with cats and dogs being two of the most popular pets. Pets seem to provide pet owners with non-trivial health benefits such as relieving stress and providing companionship. Pets often live inside the house or apartment of the pet owner.

All mammals have natural odors which can be unpleasant to owners. The odors can be a result of many things, such as secretions, sweat, skin diseases, and fecal matter. As a result, pet owners must frequently groom their pets, however, many pets do not like to be groomed or bathed. Cats for example are extremely problematic. The difficulty in grooming a pet comes from trying to maintain the pet inside the tub, for example, while also brushing, rinsing, and shampooing the pet.

Oftentimes, bathing a pet requires at least two people. One person to hold the pet while the other person brushes, and then shampoos the pet. This is because brushing, shampooing, and rinsing the pet requires more than just a brush. Typically, the pet groomer uses different brushes, water nozzles, and shampoo dispensers.

### SUMMARY

From the foregoing discussion, it should be apparent that a need exists for an apparatus, system, and method for a combination brush and shampoo dispenser. The present disclosure has been developed in response to the present state of the art, and in particular, in response to the problems and needs in the art that have not yet been fully solved by currently available brushes. Accordingly, the present disclosure has been developed to provide an apparatus, system, and method that overcome many or all of the above-discussed shortcomings in the art.

The apparatus, in one embodiment includes a handle, a brush head extending outward from a first end of the handle, the brush head having a plurality of apertures, an end coupler connected with a second end of the handle, a main channel extending from the end coupler, through the handle and brush head to the bristle pack such that the end coupler is in fluid communication with the plurality of apertures, and a reservoir formed in the brush head having a cleaning agent channel extending to and intersecting with the main channel.

The apparatus may also include a removable bristle pack connected with the brush head, the bristle pack comprising a plurality of apertures corresponding to the plurality of apertures in the brush head. The end coupler is configured to attach to a water source, the water source selected from the group consisting of an outdoor water hose, a shower head, and a sink faucet.

The apparatus may also include a ball valve connected with the main channel and configured to control a flow of water through the main channel, and a second ball valve connected with the cleaning agent channel and configured to control a flow of water through the cleaning agent channel. The ball valve is further configured to control the water pressure in the main channel such that a low pressure zone is created in the cleaning agent channel that draws the cleaning agent out of the reservoir and into the main channel to mix with the water.

In one embodiment, the main channel diverges into a left-hand channel and a right-hand channel in the brush head. The apparatus also includes, in one example, a semi-rigid region in the reservoir configured to be depressed and force the cleaning agent out of the reservoir. The semi-rigid region may be a flexible button extending from the reservoir and formed of a resilient material, or a region of flexible material configured to be depressed.

The system includes the apparatus and a semi-rigid region in the reservoir configured to be depressed and force the cleaning agent out of the reservoir. The method includes providing the apparatus, ejecting cleaning agent, and rinsing with water. The method may also include drawing cleaning agent out of the reservoir using a low pressure area in the main channel, or depressing a semi-rigid region in the reservoir.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings, in which:

FIG. 1 is a side view diagram illustrating one embodiment of a combination brush and shampoo dispenser;

FIG. 2 is a perspective view diagram illustrating another embodiment of a brush;

FIG. 3 is a perspective view diagram of a top surface of the brush;

FIG. 4 is a perspective view diagram illustrating another embodiment of the brush;

FIG. 5 is a schematic flow chart diagram illustrating a method using a brush;

FIG. 6 is a side-view cross-sectional diagram illustrating another embodiment of a combination brush and shampoo dispenser; and

FIG. 7 is a top-view cross-sectional diagram illustrating another embodiment of the brush.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Furthermore, the described features, structures, or characteristics of the disclosure may be combined in any suitable manner in one or more embodiments. In the following description, numerous specific details are provided, to give a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

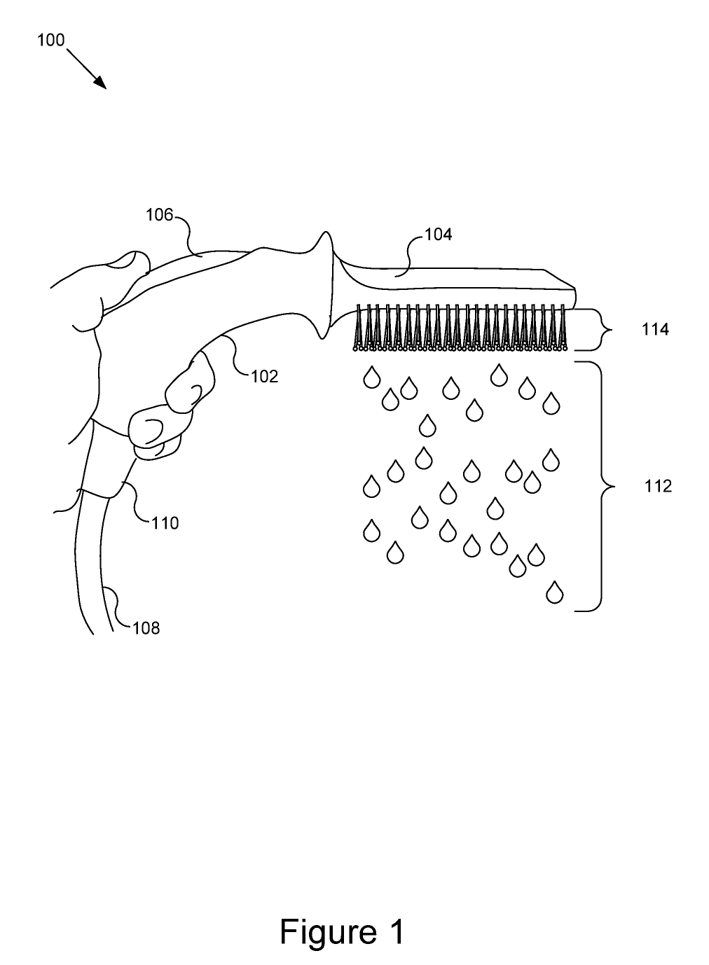

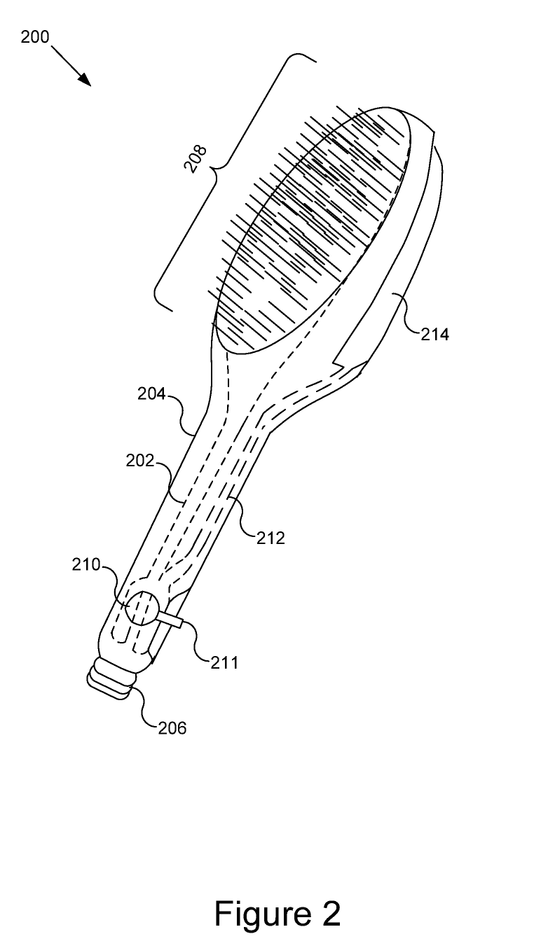

FIG. 1 is a side view diagram illustrating one embodiment of a combination brush and shampoo dispenser 100. The combination brush and shampoo dispenser (hereinafter “brush”) 100 includes a handle 102, a brush head 104, and a switch 106. The brush 100 couples with a water source via a hose 108 so that water may pass through a channel (not shown in FIG. 1) inside of the handle 102 to the brush head 104 and exit through apertures or nozzles in the brush head 104. The channel and nozzles will be described below in greater detail with reference to FIG. 2.

The brush 100 may couple to a shower head via an adapter to enable use of the brush 100 in a shower or bathtub. In another example, a hose coupler end 110 connects the brush 100 to a garden hose for outdoor use. The water pressure supplied by the water source beneficially assists in self-cleaning of the brush 100. In other words, water 112 that passes through the brush head 104 removes any hair trapped in bristles 114 of the brush 100.

The brush 100 described herein, with reference to FIG. 1, is suitable for use in any situation where a grooming brush is traditionally used. Examples of such situations include, but are not limited to, grooming humans and animals. The brush 100, furthermore, is especially useful in the grooming of pets. Generally, pets lack patience when being groomed, and therefore require the full attention of the person grooming the pet. The brush 100, by incorporating shampoo into a reservoir in the brush, allows the person to hold the pet with one hand and, with the press of the switch 106, rinse and/or shampoo the pet with the other hand.

In another embodiment, the bristles 114 of the brush 100 are configured for the removal of fleas. For example, the bristles 114 may have a tight or fine configuration suitable for use in removing fleas. As will be discussed in greater detail below, the bristles 114 may be interchangeable. In other words, the brush 100 is configured with removable bristle packs. For instance, the brush 100 is configured to receive a flea-removing bristle pack, or a general-use bristle pack.

FIG. 2 is a perspective view diagram illustrating another embodiment of a brush 200. In the depicted embodiment, the brush 200 includes a channel 202 formed inside the handle 204 of the brush 200. The channel 202 extends from the hose coupler 206 to apertures formed in the bristle pack 208. The channel 202 is configured to transport water or a mixture of a cleaning agent and water to the bristle pack 208.

In one embodiment, the brush 200 includes a ball valve 210 for controlling the flow of water through the channel 202. As illustrated, the channel 202 extends through the ball valve 210 in a manner known to those of skill in the art in the field of ball valve technology. The ball valve 210 includes a lever 211 for turning the ball valve and subsequently opening or closing the channel 202.

A second, similar, ball valve may be provided in a shampoo channel 212 for controlling the flow of a cleaning agent. The cleaning agent, in one example, is shampoo. Alternatively, other examples of cleaning agents suitable for use include, but are not limited to, medicinal agents intended for topical applications. The cleaning agent (hereinafter referred to as “shampoo”) is stored in a reservoir 214 formed within the brush 200. In the depicted embodiment, the reservoir 214 is formed inside the brush head. Alternatively, the reservoir 214 may be formed within the handle of the brush.

In one embodiment, the brush 200 utilizes a venturi effect to draw shampoo out of the reservoir, into the channel 202, and subsequently into the bristle pack. Water flow through the channel 202 causes a reduction in pressure where the shampoo channel 212 meets the channel 202. This reduction in pressure creates a partial vacuum that draws the shampoo out of the reservoir 214 and into the channel 202. Alternatively, the brush 200 may rely on gravity to feed shampoo from the reservoir 214 into the channel 202.

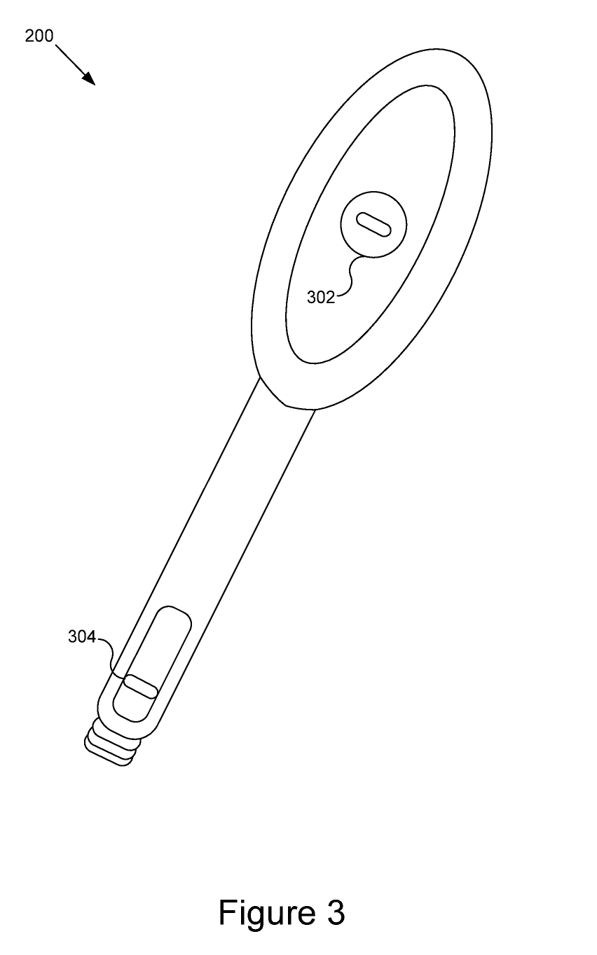

FIG. 3 is a perspective view diagram of a top surface of the brush 200. In the depicted embodiment, the brush 200 includes an opening for filling the reservoir with the cleaning agent. The brush 200 also includes a cap 302 for sealing the opening and reservoir. The cap 302 may be threaded and configured to interface with threads formed on the opening. One of skill in the art will recognize the many suitable methods for securing the cap to the opening exist and may be implemented here.

In a further embodiment, the brush 200 includes a switch 304. The switch 304 is configured to open and close the shampoo channel described above with reference to FIG. 2. Alternatively, the switch 302 may open or close the main channel 202 of FIG. 2. Additionally, and as described above, the brush 200 may include multiple switches for independent control of water and shampoo. In other words, the brush 200 may include a switch that controls the flow of water and a switch that controls the flow of shampoo, thereby allowing a person to allow the flow of water with or without shampoo. This is useful when needing to rinse the shampoo from a person or pet.

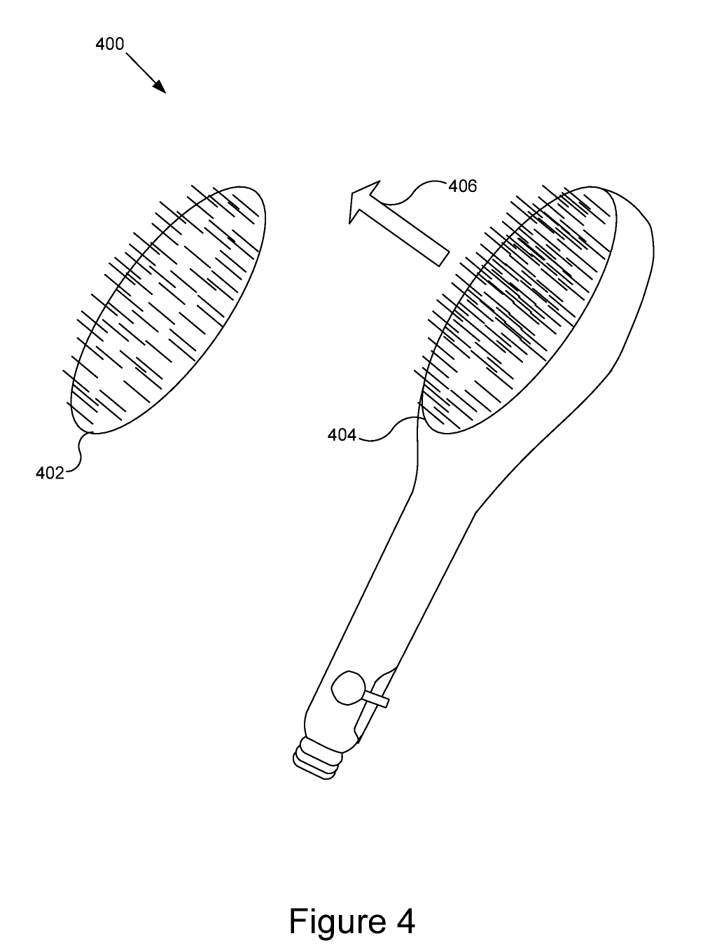

FIG. 4 is a perspective view diagram illustrating another embodiment of the brush. In one embodiment, the brush 400 includes removable bristle packs 402. As used herein, the term “bristle pack” refers to a collection of bristles mounted on a common surface. The brush 400 is configured to receive a bristle pack 402 having varying bristle densities. For example, as illustrated, bristle pack 402 has a much lower bristle density than bristle pack 404. In one example, the bristle pack 402 replaces bristle pack 404 by snapping bristle pack 402 into the brush 400 after removing bristle pack 404 as indicated by arrow 406. Alternatively, bristle packs may slide into and out of the brush 400.

The ability to replace bristle packs beneficially allows a person to adapt the brush 400 to a particular use. For example, a dog with dense hair is better suited by a bristle pack with a lower bristle density. Furthermore, a bristle pack may be configured for a specific use, such as flea removal. Flea removal requires a certain type and arrangement of bristles as is known to those of skill in the art. In a further embodiment, bristle packs may be formed having, for example, metal or plastic bristles.

The schematic flow chart diagram included herein is generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

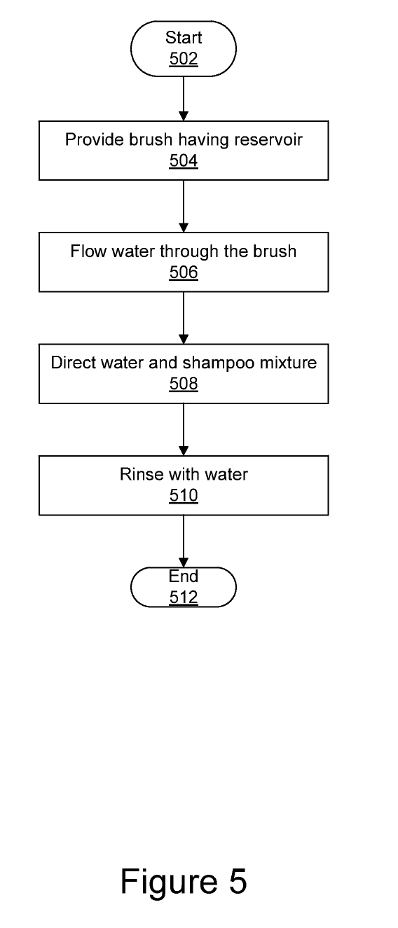

FIG. 5 is a schematic flow chart diagram illustrating a method using a brush. In one embodiment, the method starts 502 and a brush is provided 504 having a reservoir. The provided brush is configured as described above with respect to FIGS. 1-4. In other words, the brush is configured with internal channels extending from a coupler to a brush pack and a reservoir for containing a cleaning agent such as shampoo. The brush is also provided with multiple switches for controlling the flow of shampoo independently from the flow of water.

The method continues and water is flowed 506 through the brush. As described above, water flows through the channel to the brush head having a bristle pack. Openings or apertures in the bristle pack allow the application 508 of a mixture of water and shampoo to a person or animal. The shampoo enters the flow of water, as described previously, due to a venturi effect, or because of gravity.

The openings or apertures in the bristle pack direct 508 the water and shampoo to a recipient (person or animal). Once shampoo has been directed and applied to a recipient, the brush head directs a stream of water to rinse 510 the shampoo. As described above, rinsing 510 with water may be accomplished by stopping the flow of shampoo via a ball switch, for example. The method then ends 512.

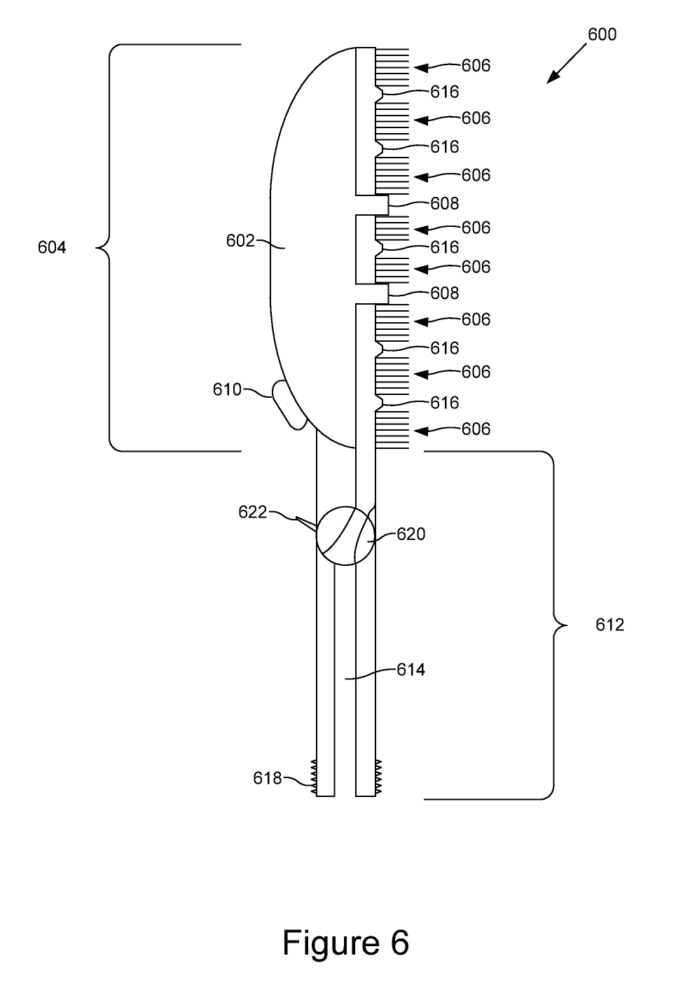

FIG. 6 is a side-view cross-sectional diagram illustrating another embodiment of a combination brush and shampoo dispenser. In one embodiment, the brush 600 is formed having a reservoir 602 for storing a cleaning agent such as shampoo. The reservoir 602 may be integrally formed inside the brush head 604, as shown, or alternatively attachable to a handle. Bristles 606 are attached to and extend away from the brush head 604. The reservoir 602 includes nozzles 608 for dispensing the cleaning agent onto either a person or pet.

Unlike the brush described above with reference to FIGS. 1-4, the brush 600 includes a semi-rigid region in the reservoir that is configured to be depressed to force the cleaning agent out of the reservoir. In one embodiment, the semi-rigid region is a dispensing “pump” 610 for pushing the cleaning agent out of the reservoir 602 and through the nozzles 608. The pump 610, in one embodiment, is a button formed of a resilient and flexible material so that when depressed the pump 610 causes the cleaning agent to exit the reservoir 602 through the nozzles 608. In a further embodiment, the pump 610 also functions as a removable cover for an opening through which a person may fill the reservoir with the cleaning agent.

In an alternative embodiment, the semi-rigid region is formed in the reservoir 602 as a region of a flexible material so that a person may simply depress any portion of the reservoir 602 to dispense shampoo through the nozzles 608. For example, the reservoir 602 may be formed of a semi-transparent rubber that also allows a person to view how much shampoo is remaining in the reservoir 602.

The brush 600 handle 612 is formed with a an interior channel 614 for transporting water from a hose to water dispensing nozzles 616 formed in the brush head 604. A threaded adapter 618 may be integrally formed in the handle 612 for coupling the handle 612 with the hose. Alternatively, the threaded adapter may be detachable so that different adapters may be attached to the handle 612. For example, the different adapters may be used to connect with different types of water sources including, but not limited to, shower heads, and outdoor water hoses.

A diverter 620 or switch is also formed in the handle 612 and configured to start and stop the flow of water through the channel 614. The diverter 620, in one embodiment, is a lever 622 extending from a ball valve. Those of skill in the art will recognize that many different types of valves may be implemented here while achieving the purpose of stopping the flow of water through the channel 614.

The brush 600 also includes bristles 606. The bristles 606 may have a tight or fine configuration for the removal of fleas. Alternatively, the bristles 606 may have a more spread out configuration for brushing pets with thick, coarse hair. In yet another embodiment, the bristles may be formed of rubber nubs for massaging the scalp or skin of a person or pet. The bristles 606 collectively may form a bristle pack that is removable from the brush head 604, as described above with reference to FIGS. 1 and 2.

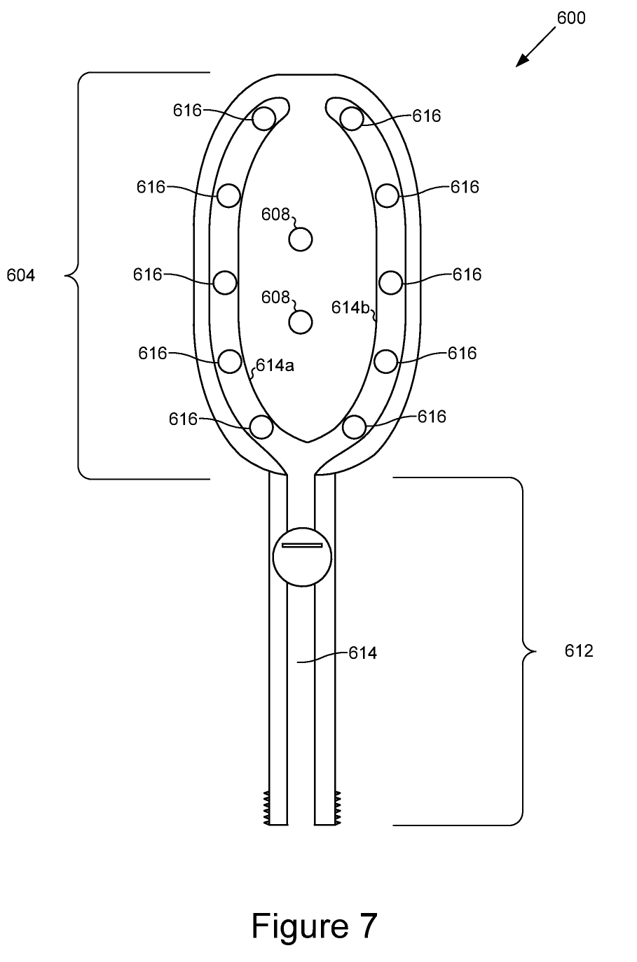

FIG. 7 is a top-view cross-sectional diagram illustrating another embodiment of the brush 600. The brush 600, as described above with reference to FIG. 6, is formed with an internal channel 614 for transporting water from a hose (that attaches to the handle 612) to one of the nozzles 616. The channel 614 extends from the handle 612 into the brush head 604. The channel 614 may diverge into a left channel 614a and a right channel 614b to form a semi-horseshoe shape as depicted. Alternatively, the channel 614 may be formed of a unitary channel that spreads across the entire brush head 604.

The nozzles 616 form a pathway from the internal channel 614 to an exterior surface of the brush head 604 so that water from the hose exits through the nozzles 616. The pressure of the water exiting through the nozzles 616 may be adjusted by partially closing the diverter 620. Additionally, the diameter of the nozzles 616 may be selected according to a desired water flow rate and pressure.

Nozzles 608 form a pathway from the reservoir 602 to the exterior surface of the brush head 604. The nozzles 608 may be centered along a longitudinal axis with the handle 612, or alternatively, the nozzles may be positioned 608 across the brush head 604 as desired.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An apparatus comprising:
a handle;
a brush head extending outward from a first end of the handle, the brush head having a plurality of apertures;
an end coupler connected with a second end of the handle;
a main channel extending from the end coupler, through the handle and brush head to the bristle pack such that the end coupler is in fluid communication with the plurality of apertures; and
a reservoir formed in the brush head having a cleaning agent channel extending to and intersecting with the main channel.

2. The apparatus of claim 1, further comprising a removable bristle pack connected with the brush head, the bristle pack comprising a plurality of apertures corresponding to the plurality of apertures in the brush head.

3. The apparatus of claim 1, wherein the end coupler is configured to attach to a water source, the water source selected from the group consisting of an outdoor water hose, a shower head, and a sink faucet.

4. The apparatus of claim 1, further comprising a ball valve connected with the main channel and configured to control a flow of water through the main channel.

5. The apparatus of claim 4, further comprising a second ball valve connected with the cleaning agent channel and configured to control a flow of water through the cleaning agent channel.

6. The apparatus of claim 4, wherein the ball valve is further configured to control the water pressure in the main channel such that a low pressure zone is created in the cleaning agent channel that draws the cleaning agent out of the reservoir and into the main channel to mix with the water.

7. The apparatus of claim 1, wherein the main channel diverges into a left-hand channel and a right-hand channel in the brush head.

8. The apparatus of claim 1, further comprising a semi-rigid region in the reservoir configured to be depressed and force the cleaning agent out of the reservoir.

9. The apparatus of claim 8, wherein the semi-rigid region is a flexible button extending from the reservoir and formed of a resilient material.

10. The apparatus of claim 8, wherein the semi-rigid region in the reservoir is a region of flexible material configured to be depressed.

11. An system comprising:
a handle;
a brush head extending outward from a first end of the handle, the brush head having a plurality of apertures;
an end coupler connected with a second end of the handle;
a main channel extending from the end coupler, through the handle and brush head to the bristle pack such that the end coupler is in fluid communication with the plurality of apertures;
a reservoir formed in the brush head having a cleaning agent channel extending to and intersecting with the brush head; and
a semi-rigid region in the reservoir configured to be depressed and force the cleaning agent out of the reservoir.

12. The system of claim 11, wherein the semi-rigid region is a flexible button extending from the reservoir and formed of a resilient material.

13. The system of claim 11, wherein the semi-rigid region in the reservoir is a region of flexible material configured to be depressed.

14. The apparatus of claim 1, further comprising a removable bristle pack connected with the brush head, the bristle pack comprising a plurality of apertures corresponding to the plurality of apertures in the brush head.

15. The apparatus of claim 1, wherein the end coupler is configured to attach to a water source, the water source selected from the group consisting of an outdoor water hose, a shower head, and a sink faucet.

16. The apparatus of claim 1, further comprising a ball valve connected with the main channel and configured to control a flow of water through the main channel.

17. The apparatus of claim 1, wherein the main channel diverges into a left-hand channel and a right-hand channel in the brush head.

18. A method comprising:
providing a handle;
providing a brush head extending outward from a first end of the handle, the brush head having a plurality of apertures;
providing an end coupler connected with a second end of the handle;
providing a main channel extending from the end coupler, through the handle and brush head to the bristle pack such that the end coupler is in fluid communication with the plurality of apertures;
providing a reservoir formed in the brush head having a cleaning agent channel extending to and intersecting with the main channel; and
ejecting cleaning agent; and
dispensing water to rinse the cleaning agent.

19. The method of claim 18, wherein ejecting cleaning agent further comprises drawing cleaning agent out of the reservoir using a low pressure area in the main channel.

20. The method of claim 18, wherein ejecting cleaning agent further comprises depressing a semi-rigid region in the reservoir.
